(19) United States
(12) Patent Application Publication
(10) Pub. No.: US 2026/0088505 A1
(43) Pub. Date: Mar. 26, 2026

(54) ANTENNA DEVICE INCLUDING DIPLEXER FORMED USING TRANSFORMER

(71) Applicant: MEDIATEK INC., Hsinchu City (TW)

(72) Inventor: Chung-Hsin Chiang, Hsinchu City (TW)

(73) Assignee: MEDIATEK INC., Hsinchu City (TW)

(21) Appl. No.: 19/321,311

(22) Filed: Sep. 8, 2025

Related U.S. Application Data
(60) Provisional application No. 63/698,101, filed on Sep. 24, 2024.

(51) Int. Cl. H01Q 5/314

(52) U.S. Cl. CPC H01Q 5/314

(57) ABSTRACT

An antenna device may include a first signal terminal, a second signal terminal, a first filter, a second filter, a transformer, and a radiator. The first signal terminal is used to access a first signal of a first frequency band. The second signal terminal is used to access a second signal of a second frequency band different from the first frequency band. The first filter includes a first terminal coupled to the first signal terminal, and a second terminal. The second filter includes a first terminal coupled to the second signal terminal, and a second terminal. The transformer includes a first terminal coupled to the first terminal of the first filter, a second terminal coupled to the first terminal of the second filter, a third terminal, and a fourth terminal. The radiator is coupled to at least the third terminal of the transformer.

### CROSS REFERENCE TO RELATED APPLICATIONS

This application claims the benefit of U.S. Provisional Application No. 63/698,101, filed on September 24, 2024. The content of the application is incorporated herein by reference.

### BACKGROUND

The proliferation of wireless communication technologies has driven increased demand for high-performance antenna systems. Modern portable electronic devices require antennas that deliver reliable signal transmission and reception while occupying minimal space within constrained device architectures. This creates competing design requirements between antenna size and performance characteristics.

Antenna radiation patterns play a crucial role in determining overall system effectiveness. Conventional antenna implementations, however, face inherent limitations in achieving both compact form factors and comprehensive coverage patterns. Existing solutions often require trade-offs between antenna dimensions and radiation performance, presenting ongoing challenges for device manufacturers.

Accordingly, there exists a continuing need for antenna technologies that can reconcile size constraints with performance demands in modern wireless communication applications.

### SUMMARY

An embodiment provides an antenna device including a first signal terminal, a second signal terminal, a first filter, a second filter, a transformer, and a radiator. The first signal terminal is used to access a first signal of a first frequency band. The second signal terminal is used to access a second signal of a second frequency band different from the first frequency band. The first filter includes a first terminal coupled to the first signal terminal, and a second terminal. The second filter includes a first terminal coupled to the second signal terminal, and a second terminal. The transformer includes a first terminal coupled to the first terminal of the first filter, a second terminal coupled to the first terminal of the second filter, a third terminal, and a fourth terminal. The radiator is coupled to at least the third terminal of the transformer.

Another embodiment provides an antenna device including a first signal terminal, a second signal terminal, a first filter, a second filter, a transformer, and a radiator. The first signal terminal is used to access a first signal of a first frequency band. The second signal terminal is used to access a second signal of a second frequency band different from the first frequency band. The first filter includes a first terminal coupled to the first signal terminal, and a second terminal. The second filter includes a first terminal coupled to the second signal terminal, and a second terminal. The transformer includes a first terminal coupled to the second terminal of the first filter, a second terminal coupled to the second terminal of the second filter, a third terminal, and a fourth terminal. The radiator is coupled to at least the third terminal of the transformer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an antenna device according to an embodiment.

FIG. 2 illustrates an antenna device according to another embodiment.

FIG. 3 illustrates an antenna device according to another embodiment.

FIG. 4 illustrates an antenna device according to another embodiment.

FIG. 5 illustrates an antenna device according to another embodiment.

FIG. 6 illustrates a filter according to an embodiment.

FIG. 7 illustrates a filter according to another embodiment.

FIG. 8 illustrates a portion of an antenna device according to another embodiment.

FIG. 9 illustrates an antenna device according to another embodiment.

FIG. 10 illustrates an antenna device according to another embodiment.

FIG. 11 illustrates a filter according to another embodiment.

### DETAILED DESCRIPTION

As used herein, when element A is described as “coupled to” element B, such coupling may be direct coupling or indirect coupling through other suitable components. Suitable components may include, but are not limited to, appropriately incorporated passive elements. As used herein, when A is described as “including” B or “comprising” B, it means that A includes but is not limited to B. As used herein, an antenna radiator may be referred to as an “antenna” or a “radiator.” As used herein, when “and/or” is used to connect two elements, it indicates the inclusion of at least one of the two elements or any reasonable combination thereof. For example, “A and/or B” encompasses the scenarios of A only, B only, and both A and B. As used herein, “radiation direction” refers to the directional characteristics of an antenna when accessing wireless signals, where the radiation direction relates to the antenna's radiation pattern. As used herein, “accessing”a signal may include receiving a signal and/or transmitting a signal.

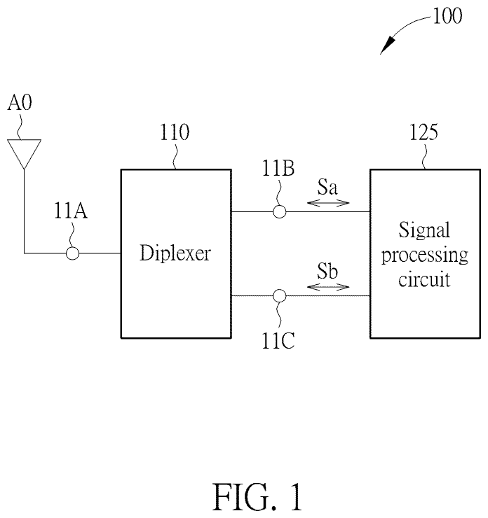

FIG. 1 illustrates an antenna device 100 according to an embodiment. The antenna device 100 may include a radiator A0 and a diplexer 110. The diplexer 110 may be a three-terminal circuit having a first terminal 11A, a second terminal 11B, and a third terminal 11C. The first terminal 11A may be coupled to the radiator A0, and the second terminal 11B and the third terminal 11C may be coupled to a signal processing circuit 125. The second terminal 11B may be used to transmit a signal Sa, and the third terminal 11C may be used to transmit a signal Sb. The signal Sa may be a high frequency band signal, and the signal Sb may be a low frequency band signal. The diplexer 110 may be used to separate and combine high band and low band signals, process carrier aggregation signals, and is positioned between the radiator A0 and the signal processing circuit 125 to ensure performance.

The architecture of FIG. 1 can facilitate signal processing; however, the diplexer 110 of FIG. 1 is a three-terminal component, where the diplexer 110 can be coupled to only one radiator A0, the radiation direction of the radiator A0 is limited to a single direction, and requires additional quarter-wave combiners. For example, if dual antennas are to be used to improve radiation coverage, additional diplexers are required.

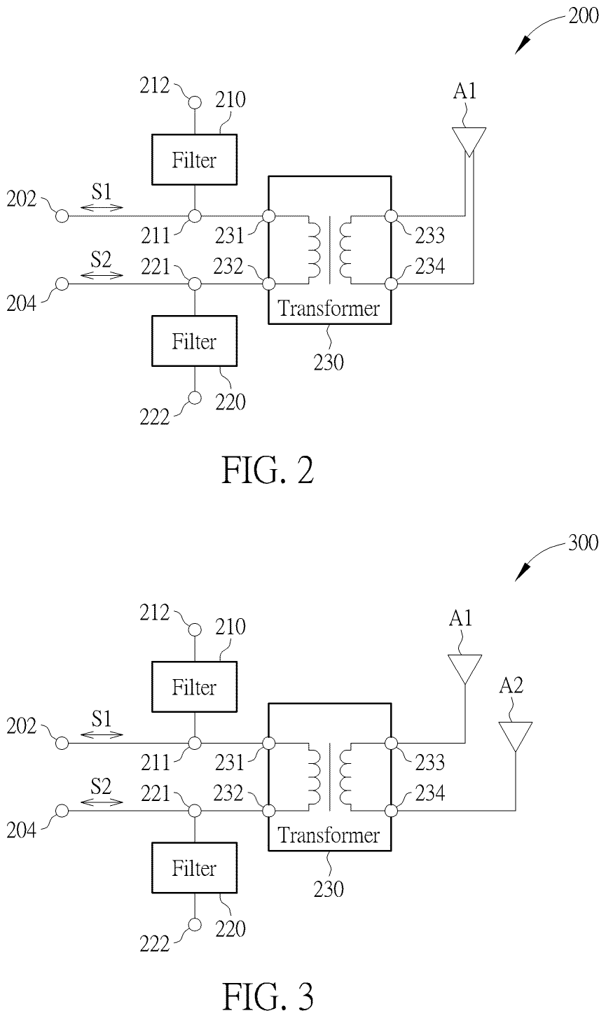

FIG. 2 illustrates an antenna device 200 according to another embodiment. The antenna device 200 may include a first signal terminal 202, a second signal terminal 204, a filter 210, a filter 220, a transformer 230, and a radiator A1.

The first signal terminal 202 may be used to access a first signal S1 of a first frequency band. The second signal terminal 204 may be used to access a second signal S2 of a second frequency band different from the first frequency band. For example, one of the first frequency band and the second frequency band may be a high frequency band, and the other may be a low frequency band.

The filter 210 may include a first terminal 211 that may be coupled to the first signal terminal 202, and a second terminal 212. The filter 220 may include a first terminal 221 that may be coupled to the second signal terminal 204, and a second terminal 222. The transformer 230 may include a first terminal 231, a second terminal 232, a third terminal 233 and a fourth terminal 234. The first terminal 231 may be coupled to the first terminal 211 of the filter 210. The second terminal 232 may be coupled to the first terminal 221 of the filter 220. The radiator A1 may be coupled to at least the third terminal 233 of the transformer 230.

The terminals 231 and 232 may be located on a primary side of the transformer 230, while the terminals 233 and 234 may be located on a secondary side of the transformer 230. The polarity between the primary side and the secondary side of the transformer 230 may be in-phase or out-of-phase, depending on the specific application requirements.

As shown in FIG. 2, the radiator A1 may be further coupled to the fourth terminal 234 of the transformer 230. In this embodiment, the radiator A1 may be a differential antenna. The differential antenna may utilize two signal paths with opposite phases to reduce common-mode noise and improve signal quality, thereby improving overall antenna performance and reducing electromagnetic interference.

FIG. 3 illustrates an antenna device 300 according to another embodiment. The similarities between the antenna device 300 and the antenna device 200 are not reiterated. In the antenna device 300, the radiator A1 is not coupled to the fourth terminal 234 of the transformer 230. The antenna device 300 further includes a radiator A2 coupled to the fourth terminal 234 of the transformer 230.

In FIG. 2, the radiator A1 may be used to access wireless signals. The circuits of the filters 210 and 220 may be designed to have the following circuit characteristics. When transmitting the signal S1, the filter 220 may operate as a short circuit at the frequency band of the signal S1, so that the signal S1 may be diverted by the filter 220 to a predetermined voltage terminal (such as a ground terminal) and may be transmitted to the radiator A1 through the transformer 230. When transmitting the signal S2, the filter 210 may operate as a short circuit at the frequency band of the signal S2, so that the signal S2 may be diverted by the filter 210 to a predetermined voltage terminal (such as a ground terminal) and may be transmitted to the radiator A1 through the transformer 230. Therefore, a single transformer 230 may be utilized to transmit both the signals S1 and S2.

In FIG. 3, the radiators A1 and A2 may be used to access wireless signals. The circuits of the filters 210 and 220 may be designed to have the following circuit characteristics. When transmitting the signal S1, the filter 220 may operate as a short circuit at the frequency band of the signal S1, so that the signal S1 may be diverted by the filter 220 to a predetermined voltage terminal (such as a ground terminal) and may be transmitted to the radiators A1 and A2 through the transformer 230. When transmitting the signal S2, the filter 210 may operate as a short circuit at the frequency band of the signal S2, so that the signal S2 may be diverted by the filter 210 to a predetermined voltage terminal (such as a ground terminal) and may be transmitted to the radiators A1 and A2 through the transformer 230. Therefore, a single transformer 230 may be utilized to transmit both the signals S1 and S2.

As described herein, when a filter operates as a short circuit at a predetermined frequency band, the filter is a virtual short circuit at that frequency band.

As used here in, when a filter is described as operating as a “short circuit,” this refers to a “virtual short circuit,” which means the filter can exhibit low impedance characteristics at a specific frequency band. This virtual short circuit can effectively divert unwanted signal components to a predetermined voltage terminal while simultaneously enabling desired signal transmission to the radiator through transformer coupling mechanisms.

In FIG. 2 and FIG. 3, the filters 210 and 220 combined with the transformer 230 may form a diplexer, thereby enabling signal processing using a single diplexer coupled to either a single antenna as shown in FIG. 2 or dual antennas as shown in FIG. 3.

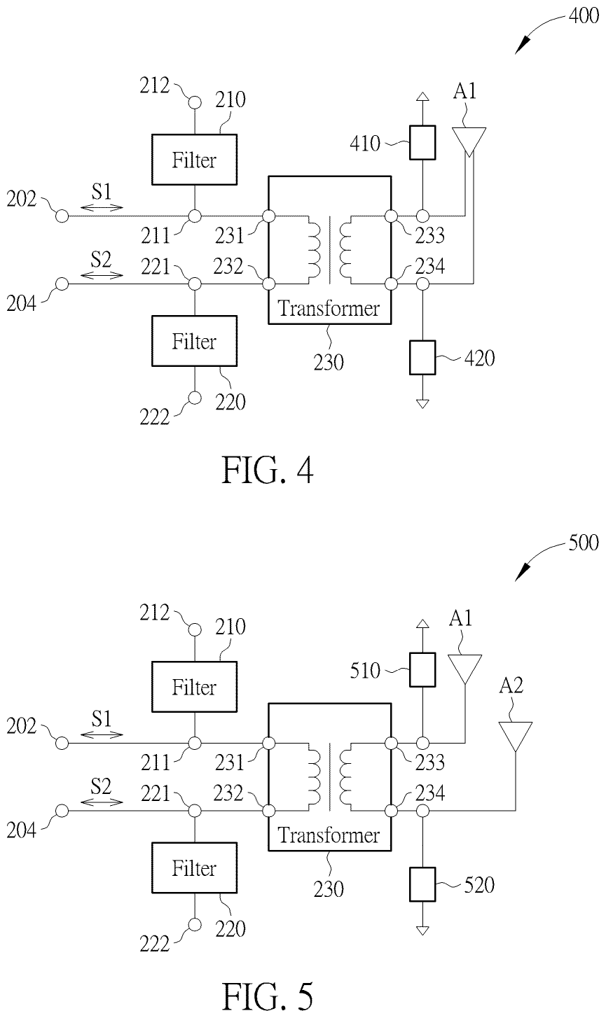

FIG. 4 illustrates an antenna device 400 according to another embodiment. The similarities between the antenna device 400 and the antenna device 200 are not reiterated. Compared to the antenna device 200, the antenna device 400 may further include switches 410 and 420. The switch 410 may include a first terminal coupled to the third terminal 233 of the transformer 230, and a second terminal coupled to a reference voltage terminal. The reference voltage terminal may be a ground terminal or a suitable reference voltage terminal. The switch 420 may include a first terminal coupled to the fourth terminal 234 of the transformer 230, and a second terminal coupled to the reference voltage terminal.

The switches 410 and 420 may be used to adjust the radiation direction of the radiator A1. The radiator A1 may be a pattern reconfigurable antenna, and the radiation direction of the radiator A1 may be adjusted and changed by controlling the switches 410 and 420. In a first mode, the switch 410 may be turned on, and the switch 420 may be turned off. In a second mode, the switch 410 may be turned off, and the switch 420 may be turned on. In a third mode, the switches 410 and 420 may both be turned off. In the above three modes, the radiator A1 may have different radiation patterns and may have different radiation directions. Therefore, by controlling the switches 410 and 420, the radiator A1 may be utilized to access wireless signals in multiple radiation directions.

FIG. 5 illustrates an antenna device 500 according to another embodiment. The antenna device 500 may be similar to the antenna device 300, but may further include switches 510 and 520. The switches 510 and 520 may be similar to the switches 410 and 420, and may be used to adjust the radiation directions of the radiators A1 and A2. When using the radiator A1 to access wireless signals, the switch 510 may be turned off, and the switch 520 may be turned on. When using the radiator A2 to access wireless signals, the switch 510 may be turned on, and the switch 520 may be turned off. If both the radiators A1 and A2 are used, the switches 510 and 520 may be turned off. The radiators A1 and A2 may have different radiation directions. By controlling the switches 510 and 520, the radiator A1 and/or the radiator A2 may be used to access wireless signals with different radiation patterns and radiation directions.

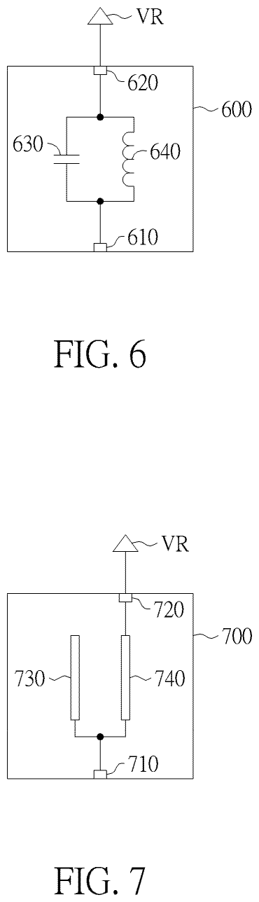

FIG. 6 illustrates a filter 600 according to an embodiment. The filters 210 and 220 may employ the structure of the filter 600. The filter 600 may have a first terminal 610 and a second terminal 620. If the structure of the filter 600 is applied to the filter 210, the terminals 610 and 620 may correspond to the terminals 211 and 212, respectively. If the structure of the filter 600 is applied to the filter 220, the terminals 610 and 620 may correspond to the terminals 221 and 222, respectively. The filter 600 may include a capacitor 630 and an inductor 640. The capacitor 630 may include a first terminal coupled to the terminal 610, and a second terminal coupled to the terminal 620. The inductor 640 may include a first terminal coupled to the terminal 610, and a second terminal coupled to the terminal 620. The terminal 620 may be coupled to a reference voltage terminal VR, such as a ground terminal or a suitable reference voltage terminal. Capacitance of the capacitor 630 and inductance of the inductor 640 may be adjusted to have an appropriate resonance frequency. If the structure of the filter 600 is applied to the filter 210 of FIG. 2 to FIG. 5, the filter 210 may operate as a short circuit at the frequency band of the signal S2 to shunt signal components of the signal S2 to the reference voltage terminal VR. Furthermore, if the structure of the filter 600 is applied to the filter 220 of FIG. 2 to FIG. 5, the filter 220 may operate as a short circuit at the frequency band of the signal S1 to shunt signal components of the signal S1 to the reference voltage terminal VR. By using the primary side circuit of the transformer 230 and the short circuit characteristics of the filters 210 and 220 at predetermined frequency bands, unwanted signal components can be shielded, unwanted signal components transmitted to the antenna can be reduced, thereby improving performance.

FIG. 7 illustrates a filter 700 according to another embodiment. The filter 700 may include a first terminal 710, a second terminal 720, and conductive stubs 730 and 740. The conductive stub 730 may include a first terminal coupled to the terminal 710, and an open second terminal. The conductive stub 740 may include a first terminal coupled to the terminal 710, and a second terminal coupled to the terminal 720. The terminal 720 may be coupled to the reference voltage terminal VR. The width and length of the conductive stubs 730 and 740 may be adjusted to adjust the resonance frequency of the filter 700. If the structure of the filter 700 is applied to the filter 210 of FIG. 4 to FIG. 5, the filter 210 may operate as a short circuit at the frequency band of the signal S2 to shunt signal components of the signal S2 to the reference voltage terminal VR. Furthermore, if the structure of the filter 700 is applied to the filter 220 of FIG. 4 to FIG. 5, the filter 220 may operate as a short circuit at the frequency band of the signal S1 to shunt signal components of the signal S1 to the reference voltage terminal VR. Thereby, by using the circuit characteristics of the transformer 230 and the filters 210, 220, unwanted signal components may be shielded to reduce unwanted signal components from being transmitted to the antenna, thereby improving performance.

As described herein, a conductive stub may be a short length of transmission line or conductive trace. The conductive stub may be formed as a metal trace, wire, or conductive pattern on a substrate such as a circuit board (e.g., a PCB) or an integrated circuit. The conductive stub may have specific electrical characteristics based on its length, width, and termination (open or short-circuited), and may be used for impedance matching, filtering, or resonance tuning.

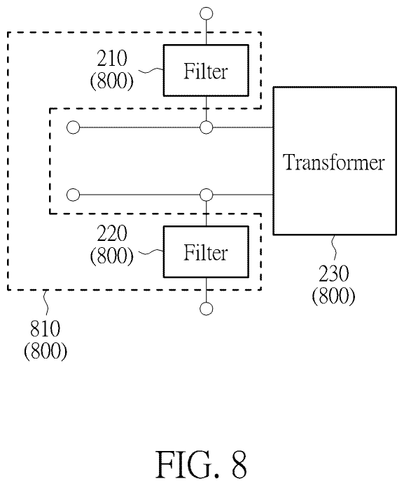

FIG. 8 illustrates a portion of an antenna device 800 according to another embodiment. FIG. 8 omits components located on the secondary side of the transformer 230, and the components located on the secondary side of the transformer 230 may utilize suitable structures as shown in FIG. 2 to FIG. 5. FIG. 8 illustrates the filters 210, 220, and the transformer 230. As described herein, one or both of the filters 210 and 220 may be disposed in an integrated circuit. However, as shown in FIG. 8, the filters 210 and 220 may be disposed on a circuit board 810, and other components of the antenna device (such as, but not limited to, the transformer 230) may be disposed in an integrated circuit. That is, according to requirements, one or both of the filters 210 and 220 may be implemented using components on the circuit board rather than being disposed within the integrated circuit. Therefore, the circuit implementation may be more flexible, and it may also be convenient for users to adjust the resonance frequency and structure of the filters on the circuit board according to requirements.

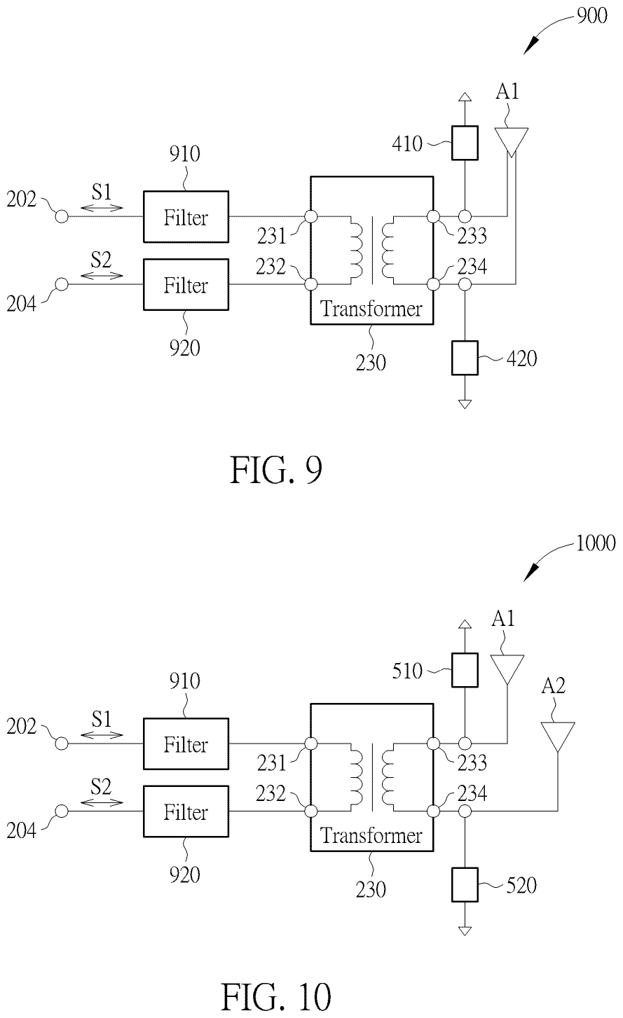

FIG. 9 illustrates an antenna device 900 according to another embodiment. The antenna device 900 may be similar to the antenna device 400, and the similarities are not reiterated. The filter structure of the antenna device 900 may be different from that of the antenna device 400. The antenna device 900 may include filters 910 and 920. The filter 910 may include a first terminal coupled to the first signal terminal 202, and a second terminal coupled to the terminal 231 of the transformer 230. The filter 920 may include a first terminal coupled to the second signal terminal 204, and a second terminal coupled to the terminal 232 of the transformer 230. In FIG. 2 to FIG. 5, each filter may be coupled to the transformer 230 and one of the signal terminals 202 and 204 through a single terminal. In FIG. 9, each filter may be coupled to the transformer 230 through one terminal, and coupled to one of the signal terminals 202 and 204 through another terminal. Similar to FIG. 4, the radiator A1 of FIG. 9 may be coupled to the terminals 233 and 234 of the transformer 230. The radiator A1 of FIG. 9 may be a differential antenna. In FIG. 9, the switches 410 and 420 may operate with one switch on and the other off, or with both switches off, allowing the radiator A1 to access wireless signals in different radiation directions. Therefore, the radiator A1 of FIG. 9 may be a pattern reconfigurable antenna whose radiation pattern and direction may be changed by the switches 410 and 420. In FIG. 9, according to specific requirements, one or both of the switches 410 and 420 may be omitted, which is also within the scope of embodiments

FIG. 10 illustrates an antenna device 1000 according to another embodiment. The antenna device 1000 may be similar to the antenna device 500, but the filter coupling arrangement of the antenna device 1000 may be similar to that of the filters 910 and 920 in FIG. 9. The similarities are not reiterated. In FIG. 10, the switch 510 may be turned off while the switch 520 is turned on to enable the radiator A1 to access wireless signals. The switch 510 may be turned on while the switch 520 is turned off to enable the radiator A2 to access wireless signals. Alternatively, both switches 510 and 520 may be turned off to enable both radiators A1 and A2 to access wireless signals. Therefore, different radiation patterns and radiation directions can be achieved. In FIG. 10, according to specific requirements, one or both of the switches 510 and 520 may be omitted, which is also within the scope of embodiments.

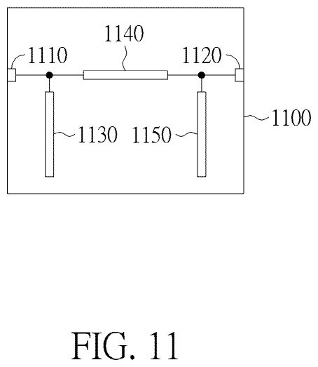

FIG. 11 illustrates a filter 1100 according to another embodiment. The filter 1100 may include a first terminal 1110 and a second terminal 1120. If the filter 1100 is applied to the filter 910 of FIG. 9 and FIG. 10, the terminal 1110 may be coupled to the first signal terminal 202, and the terminal 1120 may be coupled to the terminal 231 of the transformer 230. If the filter 1100 is applied to the filter 920 of FIG. 9 and FIG. 10, the terminal 1110 may be coupled to the second signal terminal 204, and the terminal 1120 may be coupled to the terminal 232 of the transformer 230.

The filter 1100 may further include conductive stubs 1130, 1140, and 1150. The conductive stub 1130 may include a first terminal coupled to the terminal 1110, and an open second terminal. The conductive stub 1140 may include a first terminal coupled to the terminal 1110, and a second terminal coupled to the terminal 1120. The conductive stub 1150 may include a first terminal coupled to the terminal 1120, and an open second terminal. The widths and lengths of the conductive stubs 1130, 1140, and 1150 may be adjusted to adjust the resonance frequency of the filter. If the filter 1100 is applied to the filters 910 and 920 of FIG. 9 and FIG. 10, the filter 910 may operate as a short circuit at the frequency band of the signal S2, and the filter 920 may operate as a short circuit at the frequency band of the signal S1. Therefore, unwanted signal components can flow to a low impedance path to avoid transmission through the antenna. In FIG. 11, the second terminal of the conductive stub 1130 may be an open terminal, but this is exemplary. As shown in FIG. 11, the conductive stubs 1130, 1140, and 1150 may form a second-order open stub filter. According to specific requirements, the second terminal of the conductive stub 1130 may be an open terminal or may be coupled to a suitable predetermined voltage terminal, such as but not limited to a ground terminal. Likewise, the second terminal of the conductive stub 1150 may be an open terminal or may be coupled to a suitable predetermined voltage terminal, such as but not limited to a ground terminal.

The antenna devices 900 and 1000 may be implemented in an integrated circuit. Similar to FIG. 8, in FIG. 9 and FIG. 10, one or both of the filters 910 and 920 may be implemented on a circuit board rather than within the integrated circuit, while other components (such as but not limited to the transformer 230) may be disposed within the integrated circuit.

In FIG. 4, FIG. 5, FIG. 9, and FIG. 10, the filters, transformer, and switches may form a diplexer, thereby enabling signal processing using a single diplexer coupled to either a single antenna or dual antennas.

In summary, the antenna devices according to the embodiments (such as devices 200 to 500, 900, and 1000) feature a four-terminal diplexer switch architecture that enables a single dual-band transceiver to drive either two dual-band antennas or one dual-band reconfigurable antenna. The transformer-based diplexer uses frequency-selective filtering to enable flexible radiation direction control through switches. Therefore, the need for multiple diplexers in dual antenna configurations can be eliminated. While maintaining equivalent radiation coverage, the overall circuit size can be reduced by approximately 50%. According to embodiments, a pattern reconfigurable antenna can be implemented by controlling switches. Through different operating modes, radiation patterns and directions can be dynamically adjusted, providing improved coverage and enhanced performance for wireless communication applications. Hence, the antenna devices 100 to 500, 900 and 1000 provide advantages in size reduction, coverage enhancement, operational flexibility, manufacturing compatibility, and noise performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna device, comprising:
a first signal terminal configured to access a first signal of a first frequency band;
a second signal terminal configured to access a second signal of a second frequency band different from the first frequency band;
a first filter comprising a first terminal coupled to the first signal terminal, and a second terminal;
a second filter comprising a first terminal coupled to the second signal terminal, and a second terminal;
a transformer comprising a first terminal coupled to the first terminal of the first filter, a second terminal coupled to the first terminal of the second filter, a third terminal, and a fourth terminal; and
a first radiator coupled to at least the third terminal of the transformer.

2. The antenna device of claim 1, wherein the first radiator is further coupled to the fourth terminal of the transformer.

3. The antenna device of claim 2, wherein the first radiator is a differential antenna.

4. The antenna device of claim 1, further comprising:
a second radiator coupled to the fourth terminal of the transformer.

5. The antenna device of claim 1, further comprising:
a first switch comprising a first terminal coupled to the third terminal of the transformer, and a second terminal coupled to a reference voltage terminal; and
a second switch comprising a first terminal coupled to the fourth terminal of the transformer, and a second terminal coupled to the reference voltage terminal.

6. The antenna device of claim 5, wherein:
the first radiator is further coupled to the fourth terminal of the transformer; and
the first switch and the second switch are used to adjust radiation direction of the first radiator.

7. The antenna device of claim 5, wherein:
when one of the first switch and the second switch is turned on, the other one is turned off; or
both of the first switch and the second switch are turned off.

8. The antenna device of claim 5, wherein the first filter comprises:
a capacitor comprising a first terminal coupled to the first terminal of the first filter, and a second terminal coupled to the second terminal of the first filter; and
an inductor comprising a first terminal coupled to the first terminal of the first filter, and a second terminal coupled to the second terminal of the first filter;
wherein the second terminal of the first filter is coupled to a reference voltage terminal, and the first filter operates as a short circuit at the second frequency band.

9. The antenna device of claim 5, wherein the first filter comprises:
a first conductive stub comprising a first terminal coupled to the first terminal of the first filter, and an open second terminal; and
a second conductive stub comprising a first terminal coupled to the first terminal of the first filter, and a second terminal coupled to the second terminal of the first filter;
wherein the second terminal of the first filter is coupled to a reference voltage terminal, and the first filter operates as a short circuit at the second frequency band.

10. The antenna device of claim 1, wherein the transformer is disposed on an integrated circuit, and the first filter and the second filter are disposed on a circuit board.

11. An antenna device, comprising:
a first signal terminal configured to access a first signal of a first frequency band;
a second signal terminal configured to access a second signal of a second frequency band different from the first frequency band;
a first filter comprising a first terminal coupled to the first signal terminal, and a second terminal;
a second filter comprising a first terminal coupled to the second signal terminal, and a second terminal;
a transformer comprising a first terminal coupled to the second terminal of the first filter, a second terminal coupled to the second terminal of the second filter, a third terminal, and a fourth terminal; and
a first radiator coupled to at least the third terminal of the transformer.

12. The antenna device of claim 11, wherein the first filter comprises:
a first conductive stub comprising a first terminal coupled to the first terminal of the first filter, and an open second terminal;
a second conductive stub comprising a first terminal coupled to the first terminal of the first filter, and a second terminal coupled to the second terminal of the first filter; and
a third conductive stub comprising a first terminal coupled to the second terminal of the first filter, and an open second terminal;
wherein the first filter operates as a short circuit at the second frequency band.

13. The antenna device of claim 11, wherein the first radiator is further coupled to the fourth terminal of the transformer.

14. The antenna device of claim 13, wherein the first radiator is a differential antenna.

15. The antenna device of claim 11, further comprising:
a second radiator coupled to the fourth terminal of the transformer.

16. The antenna device of claim 11, further comprising:
a first switch comprising a first terminal coupled to the third terminal of the transformer, and a second terminal coupled to a reference voltage terminal; and
a second switch comprising a first terminal coupled to the fourth terminal of the transformer, and a second terminal coupled to the reference voltage terminal.

17. The antenna device of claim 16, wherein:
the first radiator is further coupled to the fourth terminal of the transformer; and
the first switch and the second switch are used to adjust radiation direction of the first radiator.

18. The antenna device of claim 16, wherein:
when one of the first switch and the second switch is turned on, the other is turned off; or
both of the first switch and the second switch are turned off.

19. The antenna device of claim 11, wherein the transformer is disposed on an integrated circuit, and the first filter and the second filter are disposed on a circuit board.
